(19) United States
(12) Patent Application Publication
(10) Pub. No.: US 2024/0412910 A1
(43) Pub. Date: Dec. 12, 2024

(54) INDUCTOR COMPONENT

(71) Applicant: Murata Manufacturing Co., Ltd., Kyoto-fu (JP)

(72) Inventor: Takeru OZAWA, Nagaokakyo-shi (JP)

(73) Assignee: Murata Manufacturing Co., Ltd., Kyoto-fu (JP)

(21) Appl. No.: 18/649,194

(22) Filed: Apr. 29, 2024

(30) Foreign Application Priority Data
Jun. 6, 2023 (JP) 2023-093336

(51) Int. Cl. H01F 17/00; H01F 5/04

(52) U.S. Cl. CPC H01F 17/0013; H01F 5/04

(57) ABSTRACT

An inductor component includes an element body made of an insulator and a coil conductor inside the element body. The coil conductor includes conductor patterns on a plurality of respective virtual inner surfaces arranged at intervals in an axial direction of the coil conductor to form a portion of an annular track, and a coupling conductor electrically coupling two adjacent conductor patterns among the conductor patterns. At least one conductor pattern among the conductor patterns includes a first conductor pattern and a second conductor pattern that are arranged in the axial direction and are in contact with each other. In a section including an axis of the coil conductor, a center of the first conductor pattern in a direction orthogonal to the axial direction is present at a position different from a position of a center of the second conductor pattern in the direction orthogonal to the axial direction.

### CROSS-REFERENCE TO RELATED APPLICATION

This application claims benefit of priority to Japanese Patent Application No. 2023-093336, filed Jun. 6, 2023, the entire content of which is incorporated herein by reference.

### BACKGROUND

### Technical Field

The present disclosure relates to an inductor component in which a coil conductor is provided inside an element body.

### Background Art

An inductor component in which a coil conductor is provided inside an element body is required to have a high Q factor. In order to increase a Q factor of an inductor component, it is conceivable to increase a thickness of each of a plurality of conductor patterns constituting a coil conductor, for example.

An example of an inductor component having a coil conductor formed of a thick conductor pattern is disclosed in Japanese Unexamined Patent Application Publication No. 2000-36413. In the manufacturing process of the electronic component disclosed in Japanese Unexamined Patent Application Publication No. 2000-36413, a lower conductor pattern layer is formed first, and then an upper conductor pattern layer is formed on the lower conductor pattern layer. As a result, a conductor pattern having a thickness equal to the sum of a thickness of the lower conductor pattern layer and a thickness of the upper conductor pattern layer, that is, a thick conductor pattern, is formed.

### SUMMARY

An element body is limited in size. In addition, a length of a coil conductor provided inside an element body is limited. Therefore, in order to increase a thickness of a conductor pattern constituting a coil conductor without increasing the size of an element body, it is conceivable to narrow an interval between windings of the coil conductor. Here, the interval between the windings of the coil conductor is an interval between two adjacent conductor patterns among the plurality of conductor patterns constituting the coil conductor.

However, when the interval between the two adjacent conductor patterns is narrowed, stray capacitance generated between the two conductor patterns may increase. When the stray capacitance increases, a self resonant frequency (SRF) of an inductor component may become lower. When the self resonant frequency is lowered, a Q factor of the inductor component may become lower.

Accordingly, the present disclosure provides an inductor component capable of ensuring a high self resonant frequency and suppressing the generation of stray capacitance.

An inductor component of an aspect of the present disclosure includes an element body made of an insulator and a coil conductor provided inside the element body. The coil conductor includes a plurality of conductor patterns provided on a plurality of respective virtual inner surfaces arranged at intervals in an axial direction of the coil conductor to form a portion of an annular track, and a coupling conductor electrically coupling two adjacent conductor patterns among the plurality of conductor patterns. At least one conductor pattern among the plurality of conductor patterns includes a first conductor pattern and a second conductor pattern that are arranged in the axial direction and are in contact with each other. In a section including an axis of the coil conductor, a center of the first conductor pattern in a direction orthogonal to the axial direction is present at a position different from a position of a center of the second conductor pattern in the direction orthogonal to the axial direction.

According to the present disclosure, an inductor component capable of ensuring a high self resonant frequency and suppressing the generation of stray capacitance may be provided.

### BRIEF DESCRIPTION OF THE DRAWINGS

FIG. 1 is an external perspective view of an inductor component according to a first embodiment of the present disclosure;

FIG. 2 is an external perspective view of a coil conductor and an outer electrode;

FIG. 3 is an external perspective view of the coil conductor and the outer electrode;

FIG. 4 is a schematic sectional view illustrating a section A-A in FIG. 1;

FIG. 5 is a schematic sectional view illustrating a method for manufacturing an inductor component;

FIG. 6 is a schematic sectional view illustrating a method for manufacturing the inductor component;

FIG. 7 is a schematic sectional view illustrating a method for manufacturing the inductor component;

FIG. 8 is a schematic sectional view illustrating a method for manufacturing the inductor component;

FIG. 9 is a schematic sectional view illustrating a method for manufacturing the inductor component;

FIG. 10 is a schematic sectional view illustrating a method for manufacturing the inductor component;

FIG. 11 is a schematic sectional view illustrating a method for manufacturing the inductor component;

FIG. 12 is a schematic sectional view illustrating a method for manufacturing the inductor component;

FIG. 13 is a schematic sectional view illustrating a method for manufacturing the inductor component;

FIG. 14 is a schematic sectional view illustrating a method for manufacturing the inductor component;

FIG. 15 is a schematic sectional view illustrating a method for manufacturing the inductor component;

FIG. 16 is a schematic sectional view illustrating a section corresponding to the section A-A in FIG. 1 in an inductor component according to a second embodiment of the present disclosure;

FIG. 17 is a schematic sectional view illustrating a section corresponding to the section A-A in FIG. 1 in an inductor component according to a third embodiment of the present disclosure;

FIG. 18 is a schematic sectional view illustrating a section corresponding to the section A-A in FIG. 1 in an inductor component according to a fourth embodiment of the present disclosure; and

FIG. 19 is a schematic sectional view illustrating a section corresponding to the section A-A in FIG. 1 in an inductor component according to a fifth embodiment of the present disclosure.

### DETAILED DESCRIPTION

An example of the present disclosure will be described below with reference to the accompanying drawings. The following description is merely an example in nature, and is not intended to limit the present disclosure, its application, or its use. The drawings are schematic, and the ratios of respective measurements and the like do not necessarily match the actual ones. In the following description, terms indicating specific directions or positions (for example, terms including “upper”, “lower”, “right”, “left”, “front”, and “rear”) are used, as necessary. However, the use of terms indicating specific directions or positions is for facilitating the understanding of the present disclosure with reference to the drawings, and the technical scope of the present disclosure is not limited by the meanings of the terms.

### First Embodiment

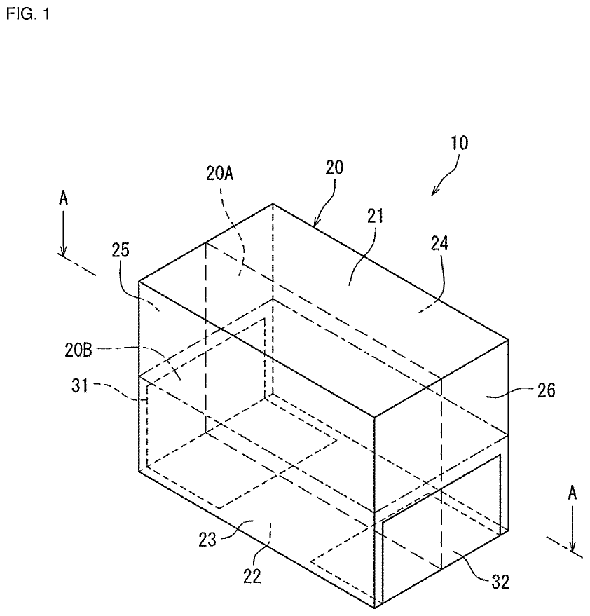

FIG. 1 is an external perspective view of an inductor component according to a first embodiment of the present disclosure.

As illustrated in FIG. 1, an inductor component 10 according to the first embodiment of the present disclosure includes an element body 20. The element body 20 has a rectangular parallelepiped shape in the first embodiment. The element body 20 includes an upper surface 21 facing upward, a lower surface 22 facing downward, and a front side surface 23, a rear side surface 24, a left side surface 25, and a right side surface 26 that connect the upper surface 21 and the lower surface 22 in the first embodiment. The front side surface 23 faces forward, and the rear side surface 24 faces rearward. The left side surface 25 faces leftward, and the right side surface 26 faces rightward. Each of the front side surface 23, the rear side surface 24, the left side surface 25, and the right side surface 26 extends downward from the upper surface 21 in a direction orthogonal to the upper surface 21 and extends upward from the lower surface 22 in a direction orthogonal to the lower surface 22. An up-down direction, a front-rear direction, and a left-right direction are directions orthogonal to each other.

The element body 20 has a multilayer structure in which a plurality of insulation layers (not illustrated) are laminated. The element body 20 is made of an insulator. The insulation layers are laminated in a direction (front-rear direction) orthogonal to the front side surface 23 and the rear side surface 24 in the first embodiment. Note that the element body 20 may have unclear interfaces between the plurality of insulation layers due to firing or the like.

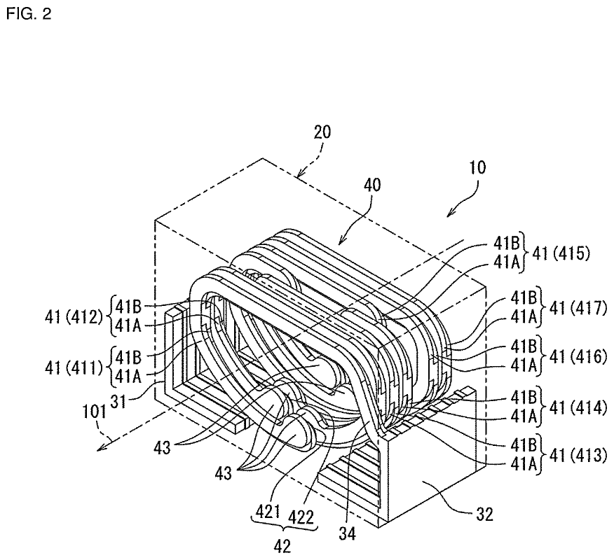

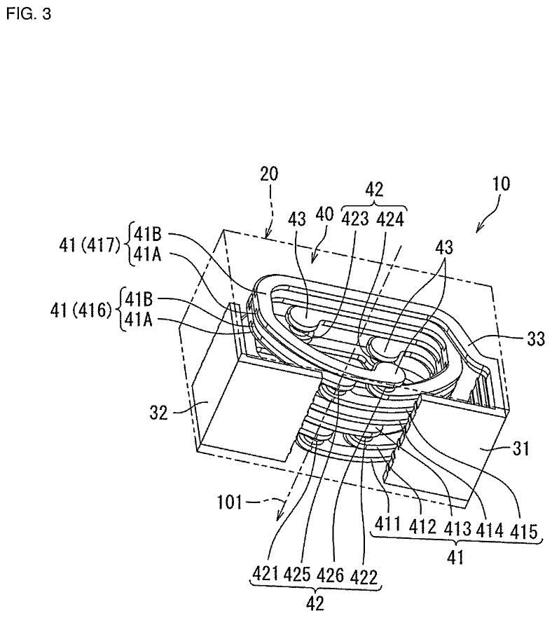

FIG. 2 is an external perspective view of a coil conductor and an outer electrode. FIG. 3 is an external perspective view of the coil conductor and the outer electrode. In FIG. 2 and FIG. 3, the outline of the element body 20 is indicated by a dashed-and-double-dotted line, thereby indicating relative positions of a coil conductor 40 and outer electrodes 31 and 32 relative to the element body 20.

The inductor component 10 includes the coil conductor 40 inside the element body 20 as illustrated in FIG. 2 and FIG. 3. The coil conductor 40 includes a plurality of (seven in the first embodiment) conductor patterns 411 to 417 and one or more (six in the first embodiment) coupling conductors 421 to 426. Hereinafter, each of the conductor patterns 411 to 417 is also collectively referred to as a conductor pattern 41, and each of the coupling conductors 421 to 426 is also collectively referred to as a coupling conductor 42.

Each of the plurality of conductor patterns 41 extends so as to form a portion of an annular track along any of the interfaces between the insulation layers. The interface can also be referred to as a virtual inner surface 20A that spreads in the up-down direction and the left-right direction inside the element body 20 as illustrated in FIG. 1. Although only one virtual inner surface 20A is illustrated in FIG. 1 as an example, the virtual inner surface 20A is set for each of the conductor patterns 41. Seven virtual inner surfaces 20A corresponding to the seven conductor patterns 411 to 417 are set in the first embodiment. The seven virtual inner surfaces 20A are arranged at intervals in the front-rear direction. Thus, the seven conductor patterns 411 to 417 are arranged at intervals in the front-rear direction. The annular track may have any shape as long as being annular. For example, the annular track is not limited to the shape illustrated in FIG. 2 and FIG. 3, and may be a circle, a rectangle, or the like.

Each of the plurality of coupling conductors 42 electrically couples two adjacent conductor patterns among the plurality of conductor patterns 41. The plurality of coupling conductors 42 are via-hole conductors that penetrate through any of the insulation layers in a thickness direction (front-rear direction) in the first embodiment. The plurality of coupling conductors 42 are not limited to the via-hole conductors and may be formed on the insulation layers by printing or the like, for example.

The plurality of conductor patterns 41 and one or more coupling conductors 42 are alternately coupled to form the coil conductor 40 extending in a spiral shape.

Each of the plurality of conductor patterns 41 has a relatively wide pad 43 at a coupling portion with the coupling conductor 42.

The conductor pattern 411, the coupling conductor 421, the conductor pattern 412, the coupling conductor 422, the conductor pattern 413, the coupling conductor 423, and the conductor pattern 414 are sequentially coupled. Further, the conductor pattern 414, the coupling conductor 424, the conductor pattern 415, the coupling conductor 425, the conductor pattern 416, the coupling conductor 426, and the conductor pattern 417 are sequentially coupled. Thus, the coil conductor 40 is formed. Each coupling conductor 42 is coupled to the adjacent conductor pattern 41 via the pad 43.

The number of conductor patterns 41 sequentially coupled to constitute the coil conductor 40, the number of coupling conductors 42, and the number of turns of the coil conductor 40 are not limited to those illustrated in the drawings and may be of any value. The number of laminated insulation layers may be of any value as well.

The inductor component 10 includes the outer electrodes 31 and 32 as illustrated in FIG. 1. The outer electrode 31 is continuously provided from the left portion of the lower surface 22 to the lower portion of the left side surface 25. The outer electrode 32 is provided continuously from the right portion of the lower surface 22 to the lower portion of the right side surface 26. Each of the outer electrodes 31 and 32 has an L shape. The portion of the outer electrode 31 provided on the lower surface 22 and the portion of the outer electrode 32 provided on the lower surface 22 are spaced apart from each other.

The outer electrode 31 is exposed to the outside of the element body 20 on the lower surface 22 and the left side surface 25. The outer electrode 32 is exposed to the outside of the element body 20 on the lower surface 22 and the right side surface 26. Each of the outer electrodes 31 and 32 is embedded in the element body 20 other than the exposed portion in the first embodiment. Surfaces of the outer electrodes 31 and 32 exposed from the element body 20 may be covered with plating of Ni, Sn, or the like.

An extended conductor pattern 33 integrally extending from the conductor pattern 417 is coupled to the outer electrode 31 as illustrated in FIG. 3. An extended conductor pattern 34 integrally extending from the conductor pattern 411 is coupled to the outer electrode 32 as illustrated in FIG. 2. That is, one end portion of the coil conductor 40 is electrically coupled to the outer electrode 31 via the extended conductor pattern 33, and the other end portion of the coil conductor 40 is electrically coupled to the outer electrode 32 via the extended conductor pattern 34. The coil conductor 40 may be electrically coupled to the outer electrodes 31 and 32 at a portion other than the one end portion or the other end portion.

When the inductor component 10 is mounted on a circuit substrate (not illustrated), the lower surface 22 is a mounting surface facing the circuit substrate in the first embodiment. An axial direction 101 of the coil conductor 40 is parallel to the mounting surface in the first embodiment. That is, the coil conductor 40 is a so-called transverse winding in the first embodiment.

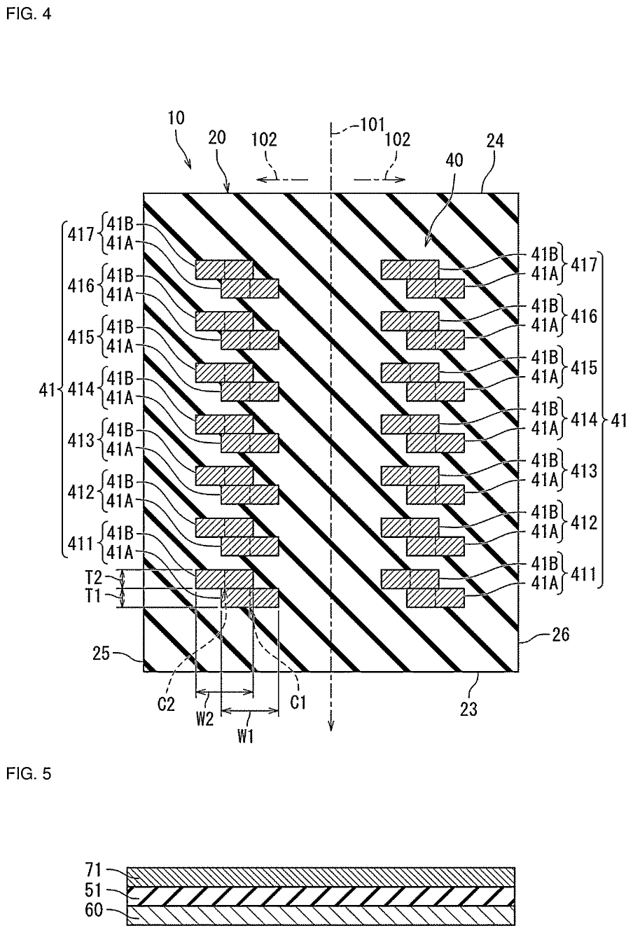

Hereinafter, the configuration of the plurality of conductor patterns 41 will be described mainly with reference to FIG. 4. FIG. 4 is a schematic sectional view illustrating a section A-A in FIG. 1. That is, a section 20B of the inductor component 10 in FIG. 1 is illustrated in FIG. 4. In FIG. 1, the section 20B is indicated by a dashed-and-dotted line.

As illustrated in FIG. 2 to FIG. 4, each of the plurality of conductor patterns 41 includes a conductor pattern 41A and a conductor pattern 41B that are arranged in the axial direction 101 of the coil conductor 40 and are in contact with each other. The axial direction 101 of the coil conductor 40 is the front-rear direction in the first embodiment. The conductor pattern 41A is an example of a first conductor pattern. The conductor pattern 41B is an example of a second conductor pattern. The conductor pattern 41A is positioned in one direction (front) of the axial direction 101, and the conductor pattern 41B is positioned in the other direction (rear) of the axial direction 101 in the first embodiment.

The conductor patterns 411 to 417 have the same configuration in the first embodiment. Therefore, in the following description, the configuration of the conductor pattern 41A and the conductor pattern 41B included in the conductor pattern 411 will be described. The other conductor patterns 412 to 417 will be described, as necessary.

As illustrated in FIG. 4, a width W1 of the conductor pattern 41A is the same as a width W2 of the conductor pattern 41B, in a section including the axis of the coil conductor 40, indicated by the dashed-and-dotted line in FIG. 4. The width W1 is the length of the conductor pattern 41A along a radial direction 102 of the coil conductor 40. The width W2 is the length of the conductor pattern 41B along the radial direction 102 of the coil conductor 40. The radial direction 102 of the coil conductor 40 is a direction extending radially from a center of the coil conductor 40 when the coil conductor 40 is viewed from the axial direction 101.

The expression that the width W1 of the conductor pattern 41A and the width W2 of the conductor pattern 41B are the same does not necessarily mean that the width W1 and the width W2 are completely the same but also includes that the width W1 and the width W2 are substantially the same.

A thickness T1 of the conductor pattern 41A is the same as a thickness T2 of the conductor pattern 41B. The thickness T1 is a length of the conductor pattern 41A parallel to the axial direction 101. The thickness T2 is a length of the conductor pattern 41B parallel to the axial direction 101.

The expression that the thickness T1 of the conductor pattern 41A and the thickness T2 of the conductor pattern 41B are the same does not necessarily mean that the thickness T1 and the thickness T2 are completely the same and includes that the thickness T1 and the thickness T2 are substantially the same.

A center C1 of the conductor pattern 41A in a direction orthogonal to the axial direction 101 is present at a position different from a center C2 of the conductor pattern 41B in the direction orthogonal to the axial direction 101, in the section including the axis of the coil conductor 40, indicated by the dashed-and-dotted line in FIG. 4. Hereinafter, the center of the conductor pattern 41A in the direction orthogonal to the axial direction 101 is referred to as the center C1. The center of the conductor pattern 41B in the direction orthogonal to the axial direction 101 is referred to as the center C2. The center C1 and the center C2 are present at different positions, in other words, the center C1 of the conductor pattern 41A is present at a position different from the center C2 of the conductor pattern 41B in a view from the axial direction 101. The center C1 is an intermediate position between one end and the other end of the conductor pattern 41A in the radial direction 102. The center C2 is an intermediate position between one end and the other end of the conductor pattern 41B in the radial direction 102.

In all the conductor patterns 411 to 417, the center C2 of the conductor pattern 41B is positioned closer to the left side surface 25 than the center C1 of the conductor pattern 41A in the first embodiment. That is, in all the conductor patterns 411 to 417, the center C1 is shifted in the same direction relative to the center C2. Conversely, the center C2 of the conductor pattern 41B may be positioned closer to the right side surface 26 than the center C1 of the conductor pattern 41A.

Next, a method for manufacturing the inductor component 10 will be described with reference to FIG. 5 to FIG. 15. FIG. 5 to FIG. 15 are schematic sectional views illustrating a method for manufacturing an inductor component 10. FIG. 5 to FIG. 15 are views corresponding to the conductor pattern 411 of the inductor component 10 illustrated in FIG. 1 to FIG. 3. A method for manufacturing a portion of the inductor component 10 corresponding to the conductor pattern 411 will be described below. The description of the method for manufacturing the portions of the inductor component 10 corresponding to the conductor patterns 412 to 417 will be omitted and referred to, as necessary.

An insulation layer 51 containing no magnetic material is formed on a substrate 60, and a conductive material 71 is formed on the insulation layer 51 as illustrated in FIG. 5. The substrate 60 is made of sintered ferrite and has a flat plate shape, for example. The insulation layer 51 is made of a polyimide resin or an inorganic material that does not contain a magnetic material, for example.

The insulation layer 51 made of polyimide resin is formed as follows, for example. The polyimide resin is coated on the substrate 60 by printing, application, or the like. Thus, the insulation layer 51 is formed on the substrate 60. The insulation layer 51 made of an inorganic material is formed on the substrate 60 by a dry process such as vapor deposition, sputtering, or chemical vapor deposition (CVD), for example.

The conductive material 71 is coated on the insulation layer 51 by printing, application, or the like. The conductive material 71 is a photosensitive substance such as a photosensitive Ag paste.

As described in detail below, the conductor pattern 41A is formed on the insulation layer 51 by patterning using a photolithography method, for example.

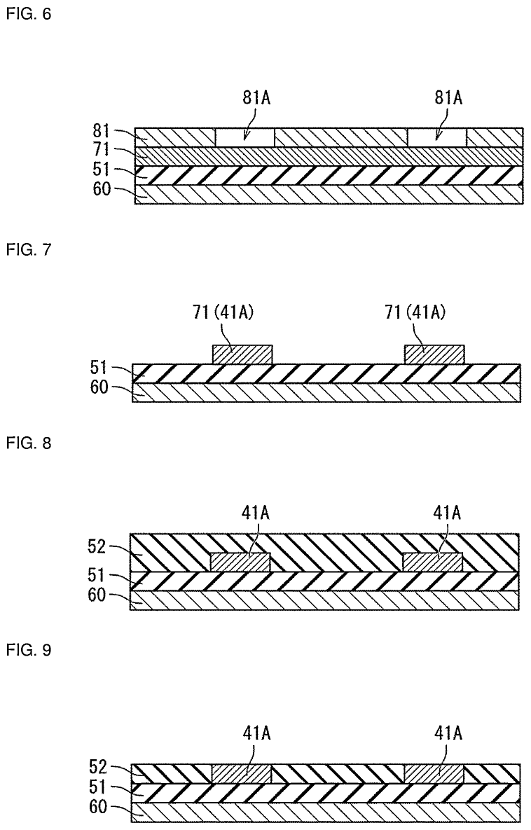

A photomask 81 is placed on the conductive material 71 as illustrated in FIG. 6. The photomask 81 has an opening 81A having the same shape as the conductor pattern 41A of the conductor pattern 411. That is, a portion of the photomask 81 is masking other than the shape of the conductor pattern 41A of the conductor pattern 411.

Next, the photomask 81 side is exposed to light. The conductive material 71 is a negative type in the first embodiment. Therefore, the solubility of a portion of the conductive material 71 exposed to light (portion exposed through the opening 81A) is lowered. Meanwhile, the solubility of a portion of the conductive material 71 not exposed to light (portion masked by the photomask 81) is not lowered. Therefore, when the development is performed after the light exposure, only the portion of the conductive material 71 exposed to light remains without being dissolved. As a result, the conductor pattern 41A of the conductor pattern 411 is formed on the insulation layer 51 as illustrated in FIG. 7.

The conductive material 71 may be a positive type. In the case above, a portion of the photomask 81 is masking the shape of the conductor pattern 41A of the conductor pattern 411.

Next, an insulation layer 52 is formed on the insulation layer 51 as illustrated in FIG. 8. The insulation layer 52 is made of a polyimide resin or an inorganic material that does not contain a magnetic material, as same as the insulation layer 51. The conductor pattern 41A of the conductor pattern 411 is covered with the insulation layer 52.

Next, the upper surface of the conductor pattern 41A of the conductor pattern 411 is exposed by washing away the insulation layer 52 with solvents, polishing the insulation layer 52, or the like, as illustrated in FIG. 9.

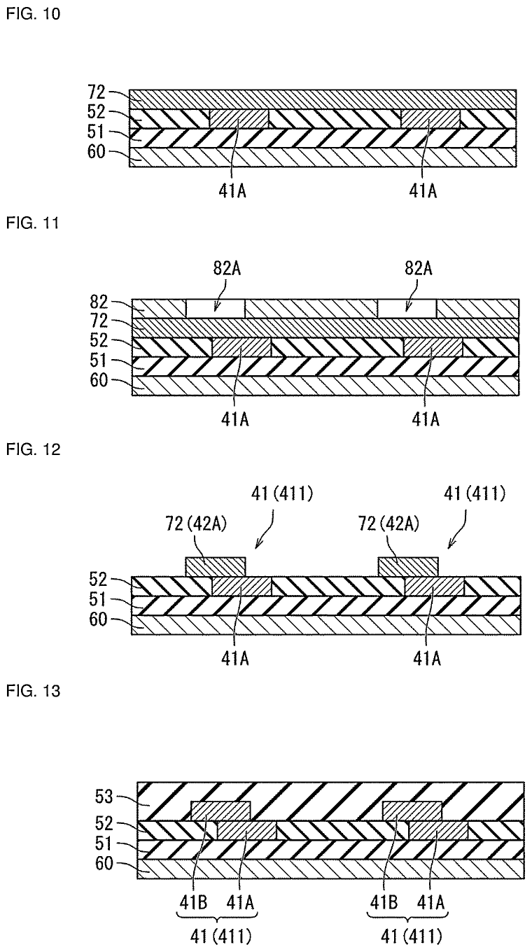

Next, a conductive material 72 is coated on the insulation layer 52 by printing, application, or the like, as with the conductor pattern 41A, as illustrated in FIG. 10. The conductive material 72 is the same material as the conductive material 71.

The conductor pattern 41B, as same as the conductor pattern 41A, is formed on the insulation layer 52 by patterning using the photolithography method, for example. This will be described in detail below.

A photomask 82 is placed on the conductive material 72 as illustrated in FIG. 11. The photomask 82 has an opening 82A having the same shape as the conductor pattern 41B of the conductor pattern 411. That is, a portion of the photomask 82 is masking other than the shape of the conductor pattern 41B of the conductor pattern 411. The opening 82A is present at a position shifted from the conductor pattern 41A formed on the insulation layer 51. However, the conductor pattern 41A formed on the insulation layer 51 is exposed through the opening 82A.

Next, the photomask 82 side is exposed to light. The conductive material 72 is a negative type in the first embodiment. Therefore, the solubility of a portion of the conductive material 72 exposed to light (portion exposed through the opening 82A) is lowered. Meanwhile, the solubility of a portion of the conductive material 72 not exposed to light (portion masked by the photomask 82) is not lowered. Therefore, when the development is performed after the light exposure, only the light exposed portion of the conductive material 72 remains without being dissolved. As described above, the conductor pattern 41A formed on the insulation layer 51 is exposed through the opening 82A. Therefore, the conductive material 72 that remains without being dissolved is coupled to the conductor pattern 41A exposed from the insulation layer 52. As a result, the conductor pattern 41B of the conductor pattern 411 is formed on the insulation layer 52 in a state of being coupled to the conductor pattern 41A, as illustrated in FIG. 12. That is, the conductor pattern 411 including the conductor pattern 41A and the conductor pattern 41B is formed.

The conductive material 72 may be a positive type. In the case above, a portion of the photomask 82 is masking the shape of the conductor pattern 41B of the conductor pattern 411.

Next, an insulation layer 53 is formed on the insulation layer 52 as illustrated in FIG. 13. The insulation layer 53 is made of a polyimide resin or an inorganic material that does not contain a magnetic material, as same as the insulation layers 51 and 52. The conductor pattern 41B of the conductor pattern 411 is covered with the insulation layer 53.

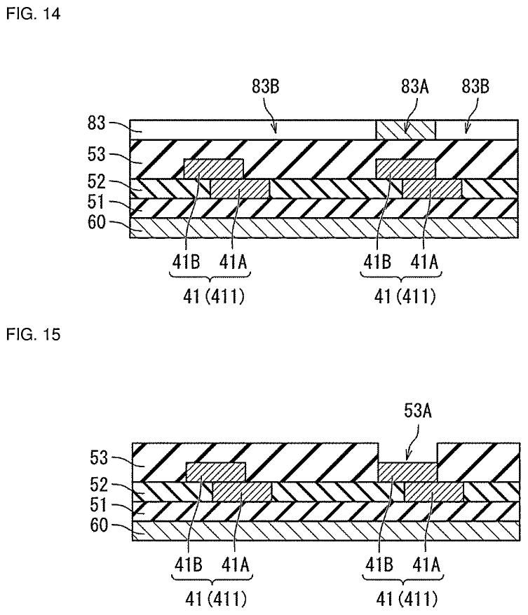

Next, a photomask 83 is placed on the insulation layer 53 as illustrated in FIG. 14. In plan view from the lamination direction of the insulation layers 51, 52, and 53 and the photomask 83, the photomask 83 has a circular mask portion 83A, and a portion 83B other than the mask portion 83A is opened. In plan view, the mask portion 83A overlaps with a portion of the conductor pattern 41B covered with the insulation layer 53. The shape of the photomask 83 in plan view is not limited to a circular shape, and may be a quadrangular shape, for example.

Next, the photomask 83 side is exposed to light. The material of the insulation layer 53 is a negative type in the first embodiment. Therefore, the solubility of the portion 83B of the insulation layer 53 exposed to light is lowered. Meanwhile, the solubility of the mask portion 83A of the insulation layer 53 not exposed to light (portion masked by the photomask 83) is not lowered. Therefore, when the development is performed after the light exposure, the portion 83B of the insulation layer 53 exposed to light remains without being dissolved, and the mask portion 83A is dissolved. As a result, a circular hole 53A is formed in the insulation layer 53, and a portion of the conductor pattern 41B is exposed through the hole 53A as illustrated in FIG. 15.

The insulation layer 53 may be a positive type. In the case above, the photomask 83 has a hole such as a circular hole in a portion corresponding to the mask portion 83A, and a portion other than the hole is the mask portion.

Then, the processes described with reference to FIG. 5 to FIG. 15 are performed again. In the state illustrated in FIG. 15, a conductive material is formed on the insulation layer 53 in the same manner as described with reference to FIG. 5. At this time, the conductive material flows into the hole 53A. The conductive material that has flowed into the hole 53A forms the coupling conductor 421 being a via-hole conductor. Subsequently, the conductor pattern 412 is formed by performing the processes described with reference to FIG. 6 to FIG. 15.

Thereafter, the processes described with reference to FIG. 5 to FIG. 15 are repeated. Thus, the coupling conductor 422, the conductor pattern 413, the coupling conductor 423, the conductor pattern 414, the coupling conductor 424, the conductor pattern 415, the coupling conductor 425, the conductor pattern 416, the coupling conductor 426, and the conductor pattern 417 are sequentially formed.

According to the first embodiment, in a view from the axial direction 101, in the conductor pattern (hereinafter, referred to as predetermined conductor pattern) including the conductor patterns 41A and 41B among the plurality of conductor patterns 41, the center C1 of the conductor pattern 41A is present at a position different from the center C2 of the conductor pattern 41B. Thus, in a view from the axial direction 101 of the coil conductor 40, the facing area of the predetermined conductor pattern and a conductor pattern provided adjacent to the predetermined conductor pattern with a space therebetween (hereinafter, referred to as adjacent conductor pattern) may be reduced.

For example, in a view from the axial direction 101, the facing area of the conductor pattern 41A of the conductor pattern 412 and the conductor pattern 41B of the conductor pattern 411 may be reduced. Here, the conductor pattern 41A is an example of the first conductor pattern, the conductor pattern 412 is an example of the predetermined conductor pattern, the conductor pattern 41B is an example of the second conductor pattern, and the conductor pattern 411 is an example of the adjacent conductor pattern.

For example, in a view from the axial direction 101, the facing area of the conductor pattern 41B of the conductor pattern 413 and the conductor pattern 41A of the conductor pattern 414 may be reduced. Here, the conductor pattern 41B is an example of the second conductor pattern, the conductor pattern 413 is an example of the predetermined conductor pattern, the conductor pattern 41A is an example of the first conductor pattern, and the conductor pattern 414 is an example of the adjacent conductor pattern.

Further, for example, even when the adjacent conductor pattern does not include the first conductor pattern and the second conductor pattern, the facing area may be reduced. Specifically, in a view from the axial direction 101, the facing area of the conductor pattern of the predetermined conductor pattern, being positioned on the adjacent conductor pattern side of the first conductor pattern and the second conductor pattern, and the adjacent conductor pattern may be reduced.

The small facing area will make the stray capacitance generated between two adjacent conductor patterns smaller. As a result, lowering of the self resonant frequency of the inductor component 10 may be suppressed, and the Q factor of the inductor component 10 may be maintained high.

According to the first embodiment, the width W1 of the conductor pattern 41A and the width W2 of the conductor pattern 41B are the same. According to the first embodiment, the inductor component 10 is easily manufactured as compared with a configuration in which the width W1 of the conductor pattern 41A and the width W2 of the conductor pattern 41B are different from each other. For example, in the manufacturing process of the inductor component 10, a photomask used for forming the conductor pattern 41A and a photomask used for forming the conductor pattern 41B may be a common photomask.

According to the first embodiment, the thickness T1 of the conductor pattern 41A and the thickness T2 of the conductor pattern 41B are the same. According to the first embodiment, the inductor component 10 is easily manufactured as compared with a configuration in which the thickness T1 of the conductor pattern 41A and the thickness T2 of the conductor pattern 41B are different from each other. For example, in the manufacturing process of the inductor component 10, a photomask used for forming the conductor pattern 41A and a photomask used for forming the conductor pattern 41B may be photomasks having the same thickness.

According to the first embodiment, in all the conductor patterns 411 to 417, the centers C1 of the conductor patterns 41A are shifted in the same direction relative to the centers C2 of the conductor patterns 41B. According to the first embodiment, the inductor component 10 is easily manufactured as compared with a configuration in which the centers C1 of the conductor patterns 41A are shifted in different directions relative to the centers C2 of the conductor patterns 41B in at least part of the plurality of conductor patterns 41. For example, according to the first embodiment, in the manufacturing process of the inductor component 10, a common photomask may be used for forming each of the plurality of conductor patterns 41.

In the first embodiment and each of embodiments which will be described later, an example has been described in which all of the conductor patterns 411 to 417 include the conductor pattern 41A and the conductor pattern 41B. However, only some of the conductor patterns 411 to 417 may include the conductor pattern 41A and the conductor pattern 41B. In the case above, the number of conductor pattern 41 including the conductor pattern 41A and the conductor pattern 41B may be one or more than one.

When each of two or more conductor patterns 41 that are part of the plurality of conductor patterns 41 includes the conductor pattern 41A and the conductor pattern 41B, in all of the two or more conductor patterns 41 being the part above, the centers C1 may be shifted in the same direction relative to the centers C2. In the case above, the shifted values between the centers C1 and the centers C2 in the two or more conductor patterns 41 being the part above may be different from each other. Of course, in each of the two or more conductor patterns 41 being the part above, the centers C1 may be shifted in different directions relative to the centers C2.

### Second Embodiment

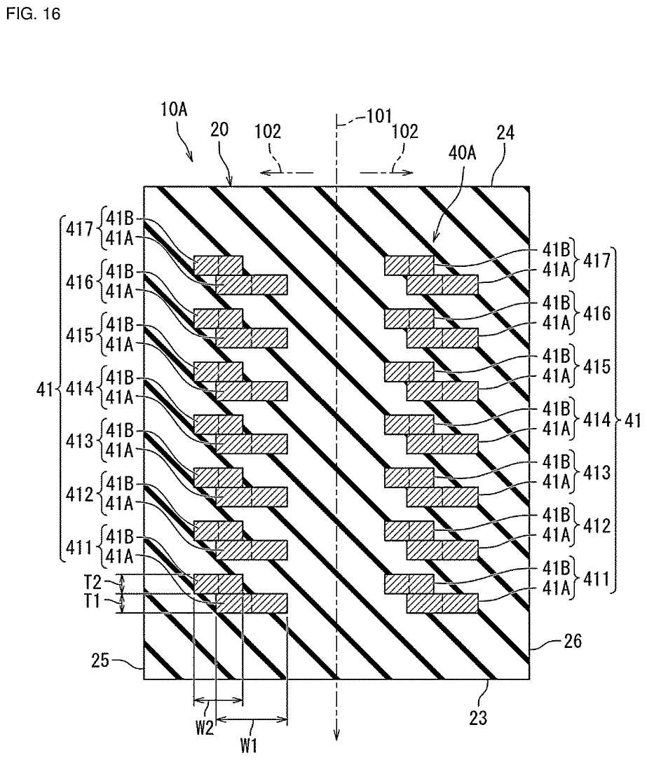

FIG. 16 is a schematic sectional view illustrating a section corresponding to the section A-A in FIG. 1 in an inductor component according to a second embodiment of the present disclosure. An inductor component 10A according to the second embodiment is different from the inductor component 10 according to the first embodiment in that a width W1 of a conductor pattern 41A and a width W2 of a conductor pattern 41B are different from each other. Hereinafter, differences from the first embodiment will be described. The same reference numerals are given to points common to the inductor component 10 according to the first embodiment, and the description thereof will be omitted in principle and will be described, as necessary.

In each of conductor patterns 41 of the inductor component 10A, the width W1 of the conductor pattern 41A is larger than the width W2 of the conductor pattern 41B as illustrated in FIG. 16. Conversely, the width W2 of the conductor pattern 41B may be larger than the width W1 of the conductor pattern 41A. In each of the conductor patterns 41 of the inductor component 10A, a thickness T1 of the conductor pattern 41A is the same as a thickness T2 of the conductor pattern 41B but may be different from each other.

According to the second embodiment, the width W1 of the conductor pattern 41A is different from the width W2 of the conductor pattern 41B. For example, the conductor pattern 41B is narrower than the conductor pattern 41A in the conductor pattern 411 as illustrated in FIG. 16. In the case above, in a view from the axial direction 101, a facing area of the conductor pattern 41B of the conductor pattern 411 and the conductor pattern 41A of the conductor pattern 412 adjacent to the conductor pattern 411 may be reduced, by the narrower amount of the width W2 of the conductor pattern 41B. The same applies to a case that the conductor pattern 41A is narrower than the conductor pattern 41B.

In the second embodiment, an example has been described in which the width W1 is larger than the width W2 in all of the plurality of conductor patterns 41. However, the width W1 may be larger than the width W2 in part of the plurality of conductor patterns 41, and the width W1 may be smaller than the width W2 in the conductor patterns 41 other than the part of the plurality of conductor patterns 41.

In the second embodiment, the example has been described in which the width W1 and the width W2 are different from each other in all of the plurality of conductor patterns 41. However, the width W1 and the width W2 may be different from each other in part of the plurality of conductor patterns 41, and the width W1 and the width W2 may be the same or substantially the same in the conductor patterns 41 other than the part of the plurality of conductor patterns 41.

### Third Embodiment

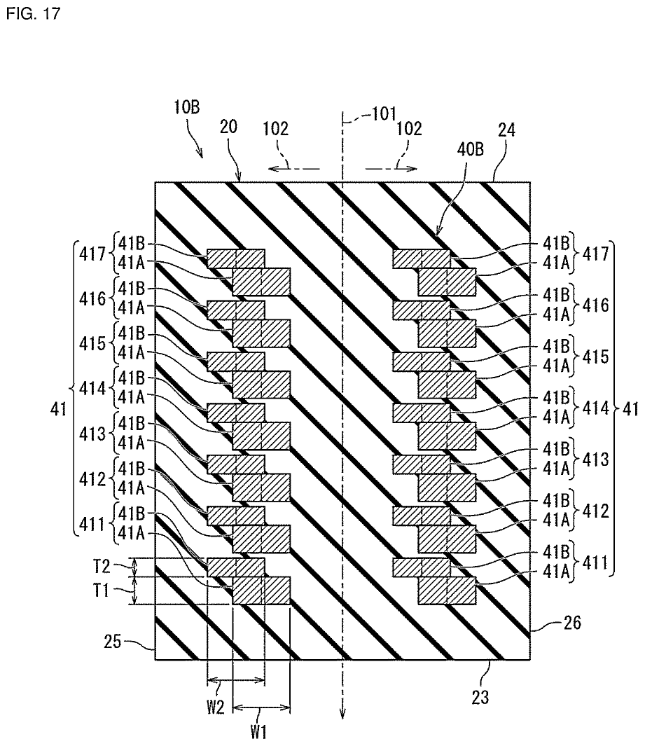

FIG. 17 is a schematic sectional view illustrating a section corresponding to the section A-A in FIG. 1 in an inductor component according to a third embodiment of the present disclosure. An inductor component 10B according to the third embodiment is different from the inductor component 10 according to the first embodiment in that a thickness T1 of a conductor pattern 41A and a thickness T2 of a conductor pattern 41B are different from each other. Hereinafter, differences from the first embodiment will be described. The same reference numerals are given to points common to the inductor component 10 according to the first embodiment, and the description thereof will be omitted in principle and will be described, as necessary.

In each of conductor patterns 41 of the inductor component 10B, the thickness T1 of the conductor pattern 41A is larger than the thickness T2 of the conductor pattern 41B as illustrated in FIG. 17. Conversely, the thickness T2 of the conductor pattern 41B may be larger than the thickness T1 of the conductor pattern 41A. In each of the conductor patterns 41 of the inductor component 10B, the width W1 of the conductor pattern 41A and the width W2 of the conductor pattern 41B are the same but may be different from each other.

According to the third embodiment, in the manufacturing process of the inductor component 10B, the thicker conductor pattern of the conductor patterns 41A and 41B is laminated first, and thus a lamination structure of the conductor pattern 41 of the manufactured inductor component 10B may be stabilized.

In the third embodiment, an example has been described in which the thickness T1 is larger than the thickness T2 in all of the plurality of conductor patterns 41. However, the thickness T1 may be larger than the thickness T2 in part of the plurality of conductor patterns 41, and the thickness T1 may be smaller than the thickness T2 in the conductor patterns 41 other than the part of the plurality of conductor patterns 41.

In the third embodiment, the example has been described in which the thickness T1 and the thickness T2 are different from each other in all of the plurality of conductor patterns 41. However, the thickness T1 and the thickness T2 may be different from each other in part of the plurality of conductor patterns 41, and the thickness T1 and the thickness T2 may be the same or substantially the same in the conductor patterns 41 other than the part of the plurality of conductor patterns 41.

### Fourth Embodiment

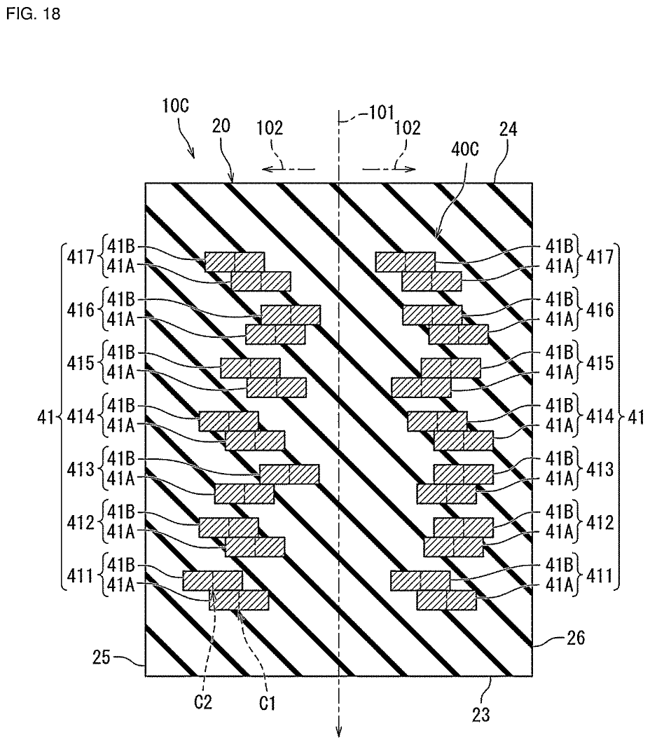

FIG. 18 is a schematic sectional view illustrating a section corresponding to the section A-A in FIG. 1 in an inductor component according to a fourth embodiment of the present disclosure. An inductor component 10C according to the fourth embodiment is different from the inductor component 10 according to the first embodiment in that a direction in which a center C1 of a conductor pattern 41A is shifted from a center C2 of a conductor pattern 41B is not constant. Hereinafter, differences from the first embodiment will be described. The same reference numerals are given to points common to the inductor component 10 according to the first embodiment, and the description thereof will be omitted in principle and will be described, as necessary.

In the inductor component 10C, in part of the plurality of conductor patterns 41, the center C1 of the conductor pattern 41A is shifted in a first direction relative to the center C2 of the conductor pattern 41B. In the inductor component 10C, in at least one conductor pattern 41 different from the part of the plurality of conductor patterns 41, the center C1 of the conductor pattern 41A is shifted in a second direction relative to the center C2 of the conductor pattern 41B. The second direction is a direction different from the first direction.

For example, in the inductor component 10C, in each of the conductor patterns 411, 414, and 417, the center C1 of the conductor pattern 41A is shifted toward the right side surface 26 relative to the center C2 of the conductor pattern 41B as illustrated in FIG. 18. In the conductor pattern 413, the center C1 of the conductor pattern 41A is shifted toward the left side surface 25 relative to the center C2 of the conductor pattern 41B. In each of the conductor patterns 412 and 415, the center C1 of the conductor pattern 41A is shifted toward the inside of the coil conductor 40 in the radial direction 102 relative to the center C2 of the conductor pattern 41B. In the conductor pattern 416, the center C1 of the conductor pattern 41A is shifted toward the outside of the coil conductor 40 in the radial direction 102 relative to the center C2 of the conductor pattern 41B.

That is, in the inductor component 10C, in the seven conductor patterns 411 to 417, there are four directions in which the center C1 of the conductor pattern 41A is shifted relative to the center C2 of the conductor pattern 41B. In the case above, one of the four directions corresponds to the first direction, and any one of the other three directions corresponds to the second direction. Here, the four directions include a direction toward the right side surface 26, a direction toward the left side surface 25, a direction toward an inner side portion of the coil conductor 40 in the radial direction 102, and a direction toward an outer side portion of the coil conductor 40 in the radial direction 102.

In the inductor component 10C, the shifting aspect in positions of the centers C1 of the conductor patterns 41A relative to the centers C2 of the conductor patterns 41B is not limited to the aspect illustrated in FIG. 18.

For example, in FIG. 18, in the inductor component 10C, the centers C1 of the conductor patterns 41A are shifted from the centers C2 of the conductor patterns 41B in four directions, but the number of directions may be two, three, five, or more.

The shifting aspect in positions may be random as illustrated in FIG. 18 or may have a certain regularity unlike FIG. 18. The aspect having a certain regularity is the following aspect, for example. In each of the conductor patterns 411, 413, 415, and 417, the center C1 of the conductor pattern 41A is shifted toward the right side surface 26 relative to the center C2 of the conductor pattern 41B. Meanwhile, in each of the conductor patterns 412, 414, and 416, the center C1 of the conductor pattern 41A is shifted toward the left side surface 25 relative to the center C2 of the conductor pattern 41B.

In a case of a configuration in which the centers C1 of the conductor patterns 41A are shifted in the same direction relative to the centers C2 of the conductor patterns 41B in all the conductor patterns 41, internal stress generated in the inductor component may be biased. According to the fourth embodiment, the centers C1 of the conductor patterns 41A are shifted in a plurality of directions relative to the centers C2 of the conductor patterns 41B. Thus, in the inductor component 10C, the internal stress generated because of the conductor patterns 41A and the internal stress generated because of the conductor patterns 41B may be canceled out. As a result, the bias in the internal stress generated in the inductor component 10C may be reduced.

### Fifth Embodiment

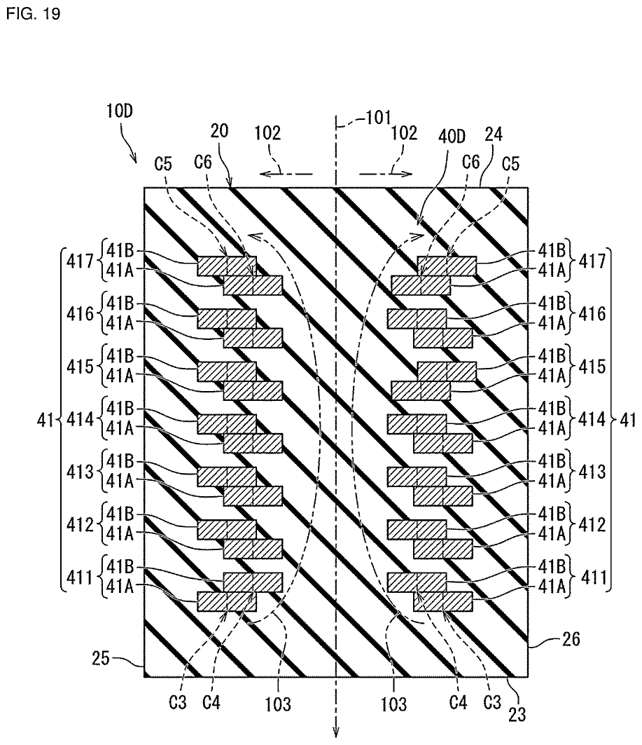

FIG. 19 is a schematic sectional view illustrating a section corresponding to the section A-A in FIG. 1 in an inductor component according to a fifth embodiment of the present disclosure. An inductor component 10D according to the fifth embodiment is different from the inductor component 10 according to the first embodiment in that each of conductor patterns positioned at end portions of the coil conductor 40 in the axial direction is positioned at an outer side portion relative to the conductor pattern adjacent thereto in the radial direction of the coil conductor 40. Hereinafter, differences from the first embodiment will be described. The same reference numerals are given to points common to the inductor component 10 according to the first embodiment, and the description thereof will be omitted in principle and will be described, as necessary.

As illustrated in FIG. 19, in the inductor component 10D, each of the conductor patterns 411 and 417 is positioned at an end portion of the coil conductor 40 in the axial direction 101. That is, in the inductor component 10D illustrated in FIG. 19, each of the conductor patterns 411 and 417 corresponds to an end conductor pattern.

Each of the conductor pattern 41A of the conductor pattern 411 and the conductor pattern 41B of the conductor pattern 417 is positioned at an outermost portion of the coil conductor 40 in the axial direction 101. In the conductor pattern 411, the conductor pattern 41B is positioned at an inner side portion of the conductor pattern 41A in the axial direction 101 of the coil conductor 40. In the conductor pattern 417, the conductor pattern 41A is positioned at an inner side portion of the conductor pattern 41B in the axial direction 101 of the coil conductor 40. As described above, in the inductor component 10D illustrated in FIG. 19, each of the conductor pattern 41A included in the conductor pattern 411 and the conductor pattern 41B included in the conductor pattern 417 corresponds to the first conductor pattern. In the inductor component 10D illustrated in FIG. 19, each of the conductor pattern 41B included in the conductor pattern 411 and the conductor pattern 41A included in the conductor pattern 417 corresponds to the second conductor pattern.

A center C3 of the conductor pattern 41A of the conductor pattern 411 is positioned at an outer side portion of a center C4 of the conductor pattern 41B of the conductor pattern 411 in the radial direction 102 of the coil conductor 40. A center C5 of the conductor pattern 41B of the conductor pattern 417 is positioned at an outer side portion of a center C6 of the conductor pattern 41A of the conductor pattern 417 in the radial direction 102 of the coil conductor 40. That is, the center of the first conductor pattern included in the end conductor pattern is positioned at an outer side portion of the center of the second conductor pattern included in the end conductor pattern in the radial direction 102 of the coil conductor 40.

Magnetic flux 103 generated in the coil conductor 40 spreads in the radial direction 102 of the coil conductor 40 at one end portion of both end portions of the coil conductor 40 in the axial direction 101 (in the vicinity of the conductor pattern 417 in the configuration illustrated in FIG. 19), and travels from the inside to the outside of the coil conductor 40 in the axial direction 101. The magnetic flux 103 generated in the coil conductor 40 narrows in the radial direction 102 of the coil conductor 40 at the other end portion of both the end portions of the coil conductor 40 in the axial direction 101 (in the vicinity of the conductor pattern 411 in the configuration illustrated in FIG. 19), and travels from the outside to the inside of the coil conductor 40 in the axial direction 101.

According to the fifth embodiment, each of the conductor patterns 411 and 417 is positioned at the end portion of the coil conductor 40 in the axial direction 101. In the case above, in the conductor pattern 411, the center C3 of the conductor pattern 41A, positioned at an outer side portion in the axial direction 101, is positioned at an outer side portion of the coil conductor 40 in the radial direction 102 relative to the center C4 of the conductor pattern 41B positioned at an inner side portion in the axial direction 101. In the conductor pattern 417, the center C5 of the conductor pattern 41B, positioned at an outer side portion in the axial direction 101, is positioned at an outer side portion of the coil conductor 40 in the radial direction 102 relative to the center C6 of the conductor pattern 41A positioned at an inner side portion in the axial direction 101. The magnetic flux 103 traveling from the inside to the outside of the coil conductor 40 and the magnetic flux 103 traveling from the outside to the inside of the coil conductor 40 are blocked by the conductor pattern 41A of the conductor pattern 411 and the conductor pattern 41B of the conductor pattern 417 respectively, but the magnitude of the blockage may be reduced with the configuration above. As a result, the acquisition efficiency of an L value of the inductor component 10D may be increased.

### Modified Example

In each of the above-described embodiments, an example in which the axial direction 101 of the coil conductor 40 is parallel to the mounting surface, that is, an example has been described in which the coil conductor 40 is a transverse winding. However, the coil conductor 40 is not limited to the transverse winding. For example, the axial direction 101 of the coil conductor 40 may be perpendicular to the mounting surface. That is, the coil conductor 40 may be a so-called longitudinal winding.

In each of the above-described embodiments, an example has been described in which each of the outer electrodes 31 and 32 has an L shape, but the shape of each of the outer electrodes 31 and 32 is not limited to an L shape.

For example, each of the outer electrodes 31 and 32 may be provided only on the lower surface 22 of the element body 20.

For example, the outer electrode 31 may be provided to cover the left portion of the element body 20, and the outer electrode 32 may be provided to cover the right portion of the element body 20. Specifically, the outer electrode 31 may be constituted of an entire surface of the left side surface 25 and a portion extending from an edge portion of the left side surface 25 to the upper surface 21, the lower surface 22, the front side surface 23, and the rear side surface 24. The outer electrode 32 may be constituted of an entire surface of the right side surface 26 and a portion extending from an edge portion of the right side surface 26 to the upper surface 21, the lower surface 22, the front side surface 23, and the rear side surface 24.

The inductor component described above may also be expressed as follows.
(1) An inductor component according to an aspect of the present disclosure, comprising an element body made of an insulator; and a coil conductor provided inside the element body. The coil conductor includes a plurality of conductor patterns provided on a plurality of respective virtual inner surfaces arranged at intervals in an axial direction of the coil conductor to form a portion of an annular track, and a coupling conductor electrically coupling two adjacent conductor patterns among the plurality of conductor patterns. At least one conductor pattern among the plurality of conductor patterns includes a first conductor pattern and a second conductor pattern that are arranged in the axial direction and are in contact with each other. Also, in a section including an axis of the coil conductor, a center of the first conductor pattern in a direction orthogonal to the axial direction is present at a position different from a position of a center of the second conductor pattern in the direction orthogonal to the axial direction.
(2) The inductor component according to (1), wherein in a section including the axis, a width of the first conductor pattern, which is a length of the first conductor pattern along a radial direction of the coil conductor, may be equal to a width of the second conductor pattern, which is a length of the second conductor pattern along the radial direction.
(3) The inductor component according to (1), wherein in a section including the axis, a width of the first conductor pattern, which is a length of the first conductor pattern along a radial direction of the coil conductor, may be different from a width of the second conductor pattern, which is a length of the second conductor pattern along the radial direction.
(4) The inductor component according to any one of (1) to (3), wherein a thickness of the first conductor pattern, which is a length of the first conductor pattern parallel to the axial direction, may be equal to a thickness of the second conductor pattern, which is a length of the second conductor pattern parallel to the axial direction.
(5) The inductor component according to any one of (1) to (3), wherein a thickness of the first conductor pattern, which is a length of the first conductor pattern parallel to the axial direction, may be different from a thickness of the second conductor pattern, which is a length of the second conductor pattern parallel to the axial direction.
(6) The inductor component according to any one of (1) to (5), wherein at least two conductor patterns among the plurality of conductor patterns may include the first conductor pattern positioned in one direction of the axial direction and the second conductor pattern positioned in the other direction of the axial direction. Also, in all of the at least two conductor patterns, centers of the first conductor patterns in the direction orthogonal to the axial direction may be shifted in the same direction relative to centers of the second conductor patterns in the direction orthogonal to the axial direction.
(7) The inductor component according to any one of (1) to (5), wherein at least two conductor patterns among the plurality of conductor patterns may include the first conductor pattern positioned in one direction of the axial direction and the second conductor pattern positioned in the other direction of the axial direction. Also, in conductor patterns being part of the at least two conductor patterns, centers of the first conductor patterns in the direction orthogonal to the axial direction may be shifted in a first direction relative to centers of the second conductor patterns in the direction orthogonal to the axial direction. In at least one conductor pattern other than the part of conductor patterns among the at least two conductor patterns, a center of the first conductor pattern in the direction orthogonal to the axial direction may be shifted in a second direction different from the first direction relative to a center of the second conductor pattern in the direction orthogonal to the axial direction.
(8) The inductor component according to any one of (1) to (7), wherein in two end conductor patterns positioned at both end portions of the coil conductor in the axial direction among the plurality of conductor patterns, the first conductor pattern included in the end conductor pattern may be positioned at an outermost side portion of the coil conductor in the axial direction, and the second conductor pattern included in the end conductor pattern may be positioned at an inner side portion of the first conductor pattern included in the end conductor pattern in the axial direction. Also, a center of the first conductor pattern included in the end conductor pattern in the direction orthogonal to the axial direction may be positioned at an outer side portion of the coil conductor in a radial direction relative to a center of the second conductor pattern included in the end conductor pattern in the direction orthogonal to the axial direction.

Note that, by appropriately and arbitrarily combining embodiments among the various embodiments, the effects of the respective embodiments may be achieved.

Although the present disclosure has been fully described in connection with the preferred embodiments thereof with reference to the accompanying drawings, it is to be noted that various variations and modifications will become apparent to those skilled in the art. It is to be understood that such variations and modifications are to be included within the scope of the present disclosure as defined by the appended aspects of the disclosure.

What is claimed is:

1. An inductor component, comprising:
an element body including an insulator; and
a coil conductor inside the element body,
wherein
the coil conductor includes a plurality of conductor patterns on a plurality of respective virtual inner surfaces arranged at intervals in an axial direction of the coil conductor to configure a portion of an annular track, and a coupling conductor electrically coupling two adjacent conductor patterns among the plurality of conductor patterns,
at least one conductor pattern among the plurality of conductor patterns includes a first conductor pattern and a second conductor pattern that are arranged in the axial direction and are in contact with each other, and
in a cross section including an axis of the coil conductor, a center of the first conductor pattern in a direction orthogonal to the axial direction is located at a different position from a center of the second conductor pattern in the direction orthogonal to the axial direction.

2. The inductor component according to claim 1, wherein
in a section including the axis, a width of the first conductor pattern, which is a length of the first conductor pattern along a radial direction of the coil conductor, is equal to a width of the second conductor pattern, which is a length of the second conductor pattern along the radial direction.

3. The inductor component according to claim 1, wherein
in a section including the axis, a width of the first conductor pattern, which is a length of the first conductor pattern along a radial direction of the coil conductor, is different from a width of the second conductor pattern, which is a length of the second conductor pattern along the radial direction.

4. The inductor component according to claim 1, wherein
a thickness of the first conductor pattern, which is a length of the first conductor pattern parallel to the axial direction, is equal to a thickness of the second conductor pattern, which is a length of the second conductor pattern parallel to the axial direction.

5. The inductor component according to claim 1, wherein
a thickness of the first conductor pattern, which is a length of the first conductor pattern parallel to the axial direction, is different from a thickness of the second conductor pattern, which is a length of the second conductor pattern parallel to the axial direction.

6. The inductor component according to claim 1, wherein
at least two conductor patterns among the plurality of conductor patterns include the first conductor pattern positioned in one direction of the axial direction and the second conductor pattern positioned in another direction of the axial direction, and
in all of the at least two conductor patterns, centers of the first conductor patterns in the direction orthogonal to the axial direction are shifted in the same direction relative to centers of the second conductor patterns in the direction orthogonal to the axial direction.

7. The inductor component according to claim 1, wherein
at least two conductor patterns among the plurality of conductor patterns include the first conductor pattern positioned in one direction of the axial direction and the second conductor pattern positioned in another direction of the axial direction,
in conductor patterns being part of the at least two conductor patterns, centers of the first conductor patterns in the direction orthogonal to the axial direction are shifted in a first direction relative to centers of the second conductor patterns in the direction orthogonal to the axial direction, and
in at least one conductor pattern other than the part of conductor patterns among the at least two conductor patterns, a center of the first conductor pattern in the direction orthogonal to the axial direction is shifted in a second direction different from the first direction relative to a center of the second conductor pattern in the direction orthogonal to the axial direction.

8. The inductor component according to claim 1, wherein
in two end conductor patterns positioned at both end portions of the coil conductor in the axial direction among the plurality of conductor patterns, the first conductor pattern included in the end conductor pattern is positioned at an outermost side in the axial direction of the coil conductor, and the second conductor pattern included in the end conductor pattern is positioned at more inner side than the first conductor pattern included in the end conductor pattern in the axial direction, and
a center of the first conductor pattern included in the end conductor pattern in the direction orthogonal to the axial direction is positioned at more outer side in a radial direction of the coil conductor than a center of the second conductor pattern included in the end conductor pattern in the direction orthogonal to the axial direction.

9. The inductor component according to claim 2, wherein
a thickness of the first conductor pattern, which is a length of the first conductor pattern parallel to the axial direction, is equal to a thickness of the second conductor pattern, which is a length of the second conductor pattern parallel to the axial direction.

10. The inductor component according to claim 3, wherein
a thickness of the first conductor pattern, which is a length of the first conductor pattern parallel to the axial direction, is equal to a thickness of the second conductor pattern, which is a length of the second conductor pattern parallel to the axial direction.

11. The inductor component according to claim 2, wherein
a thickness of the first conductor pattern, which is a length of the first conductor pattern parallel to the axial direction, is different from a thickness of the second conductor pattern, which is a length of the second conductor pattern parallel to the axial direction.

12. The inductor component according to claim 3, wherein
a thickness of the first conductor pattern, which is a length of the first conductor pattern parallel to the axial direction, is different from a thickness of the second conductor pattern, which is a length of the second conductor pattern parallel to the axial direction.

13. The inductor component according to claim 2, wherein
at least two conductor patterns among the plurality of conductor patterns include the first conductor pattern positioned in one direction of the axial direction and the second conductor pattern positioned in another direction of the axial direction, and
in all of the at least two conductor patterns, centers of the first conductor patterns in the direction orthogonal to the axial direction are shifted in the same direction relative to centers of the second conductor patterns in the direction orthogonal to the axial direction.

14. The inductor component according to claim 3, wherein
at least two conductor patterns among the plurality of conductor patterns include the first conductor pattern positioned in one direction of the axial direction and the second conductor pattern positioned in another direction of the axial direction, and
in all of the at least two conductor patterns, centers of the first conductor patterns in the direction orthogonal to the axial direction are shifted in the same direction relative to centers of the second conductor patterns in the direction orthogonal to the axial direction.

15. The inductor component according to claim 2, wherein
at least two conductor patterns among the plurality of conductor patterns include the first conductor pattern positioned in one direction of the axial direction and the second conductor pattern positioned in another direction of the axial direction,
in conductor patterns being part of the at least two conductor patterns, centers of the first conductor patterns in the direction orthogonal to the axial direction are shifted in a first direction relative to centers of the second conductor patterns in the direction orthogonal to the axial direction, and
in at least one conductor pattern other than the part of conductor patterns among the at least two conductor patterns, a center of the first conductor pattern in the direction orthogonal to the axial direction is shifted in a second direction different from the first direction relative to a center of the second conductor pattern in the direction orthogonal to the axial direction.

16. The inductor component according to claim 3, wherein
at least two conductor patterns among the plurality of conductor patterns include the first conductor pattern positioned in one direction of the axial direction and the second conductor pattern positioned in another direction of the axial direction,
in conductor patterns being part of the at least two conductor patterns, centers of the first conductor patterns in the direction orthogonal to the axial direction are shifted in a first direction relative to centers of the second conductor patterns in the direction orthogonal to the axial direction, and
in at least one conductor pattern other than the part of conductor patterns among the at least two conductor patterns, a center of the first conductor pattern in the direction orthogonal to the axial direction is shifted in a second direction different from the first direction relative to a center of the second conductor pattern in the direction orthogonal to the axial direction.

17. The inductor component according to claim 2, wherein
in two end conductor patterns positioned at both end portions of the coil conductor in the axial direction among the plurality of conductor patterns, the first conductor pattern included in the end conductor pattern is positioned at an outermost side in the axial direction of the coil conductor, and the second conductor pattern included in the end conductor pattern is positioned at more inner side than the first conductor pattern included in the end conductor pattern in the axial direction, and
a center of the first conductor pattern included in the end conductor pattern in the direction orthogonal to the axial direction is positioned at more outer side in a radial direction of the coil conductor than a center of the second conductor pattern included in the end conductor pattern in the direction orthogonal to the axial direction.

18. The inductor component according to claim 3, wherein
in two end conductor patterns positioned at both end portions of the coil conductor in the axial direction among the plurality of conductor patterns, the first conductor pattern included in the end conductor pattern is positioned at an outermost side in the axial direction of the coil conductor, and the second conductor pattern included in the end conductor pattern is positioned at more inner side than the first conductor pattern included in the end conductor pattern in the axial direction, and
a center of the first conductor pattern included in the end conductor pattern in the direction orthogonal to the axial direction is positioned at more outer side in a radial direction of the coil conductor than a center of the second conductor pattern included in the end conductor pattern in the direction orthogonal to the axial direction.
